(19) United States
(12) Patent Application Publication
(10) Pub. No.: US 2005/0057951 A1
(43) Pub. Date: Mar. 17, 2005

(54) Controlled synchronous rectifier for controlling an output voltage of a switched mode power supply

(75) Inventor: Ralf Schroder gen. Berghegger, Glandorf (DE)

Correspondence Address: MICHAEL BEST & FRIEDRICH, LLP, 100 E WISCONSIN AVENUE, MILWAUKEE, WI, 53202, US

(73) Assignee: Friwo Mobile Power GmBH, Ostbevern (DE)

(21) Appl. No.: 10/899,867

(22) Filed: Jul. 27, 2004

(30) Foreign Application Priority Data
Jul. 28, 2003 (DE) 103 34 338.5

(51) Int. Cl. H02M 1/00

(52) U.S. Cl. 363/81

(57) ABSTRACT

The present invention relates to a control circuit for controlling the output voltage of a switched mode power supply which comprises a primary-side switch and a transformer with a primary winding and a secondary winding. The output voltage of the switched mode power supply is adapted to be tapped at a capacitor which is connected in parallel to said secondary winding. The control circuit is adapted to be connected to a connection of the capacitor and a connection of the secondary winding, said control circuit being a controllable synchronous rectifier. Making use of this control circuit, an improved control accuracy can be achieved and an existing residual ripple of the output voltage can be compensated.

### BACKGROUND OF THE INVENTION

1. Field of the Invention

The present invention relates generally to control circuits for controlling the output voltage of a switched mode power supply. In particular, the present invention relates to a control circuit in a primary-controlled switched mode power supply, which comprises a primary-side switch and a transformer with a primary winding and a secondary winding, the output voltage being adapted to be tapped at a capacitor which is connected in parallel to said secondary winding. The present invention additionally relates to a switched mode power supply for generating an output voltage, said switched mode power supply making use of the control circuit. Furthermore, the present invention concerns a method of controlling an output voltage of a switched mode power supply.

2. Description of the Related Art

Switched mode power supplies are clocked power supply units which chop a rectified, filtered mains voltage. Such switched mode power supplies are nowadays preferred to conventional power packs with power transformers for many cases of use, since, from a certain performance category onwards, they have a better efficiency and require in particular less space.

The use of electronic switches causes, essentially, only switching losses, the voltage transformed being, instead of the mains voltage, a high-frequency a.c. voltage. Instead of the normal mains frequency of 50 Hz or 60 Hz, the high-frequency a.c. voltage can e.g. be in the range of from 20 kHz to 200 kHz.

Since the necessary numbers of windings of the transformer decrease inversely proportional to the frequency, the ohmic losses can be markedly reduced in this way and the transformer required becomes much smaller. Control is effected either by varying the pulse duty ratio at a constant frequency or by varying the frequency at a fixed or variable pulse duty ratio.

The magnitude of the output voltage can be determined by the clock ratio with which the electronic switch is closed. The voltage chopped by the electronic switch can be transformed into any other voltage and rectified. For obtaining from this a desired d.c. output voltage of a switched mode power supply, a lowpass filter, which forms the average value over time, is first of all required, said lowpass filter being e.g. an LC lowpass filter. Since said lowpass filter is located on the secondary side of the transformer, such power packs are also referred to as secondary-clocked switched mode power supplies.

When, for controlling a desired d.c. output voltage, the pulse duty ratio of the switch is varied on the primary side, the switched mode power supplies in question are referred to as primary-clocked switched mode power supplies.

According to both principles, a switch is used for generating an a.c. voltage whose pulse duty ratio determines the output voltage. Primary-clocked switched mode power supplies are normally preferred because of their higher efficiency, and secondary-clocked power supplies are mainly used as d.c. converters for small powers.

FIG. 1 shows a circuit diagram of a conventional primary-clocked switched mode power supply, said switched mode power supply comprising a primary-side switch 100 and a transformer with a primary winding 102 and a secondary winding 103. A series connection comprising said primary winding and said switch receives an input voltage which is to be converted into a specific output voltage. The switch 100 is controlled by a primary-side controller. A primary-side controller is known e.g. from DE 19805847 A1, and is therefore not described in detail.

A diode 105 is connected in series with the secondary winding 103, said diode 105 decoupling the secondary-side circuit from the transformer in certain operating phases. The series connection comprising the secondary winding and the diode has a capacitor 104 connected in parallel thereto. The capacitor 104 is a smoothing capacitor for smoothing the power pack output voltage.

In the closed condition of the switch, the anode-cathode voltage of the rectifier diode 105 is negative, i.e. a current does not flow through the secondary winding of the transformer. In the primary winding a magnetization current flows, which is stored in the transformer as magnetic energy. When the switch is opened, the voltage at the windings is reversed. The voltage at the secondary winding increases until the rectifier diode 105 becomes conductive, i.e. it increases to the value of the output voltage Uout. Since the magnetic flux in the transformer is approximately constant, the current flowing in the secondary winding at the moment the switch is opened will be the current of the primary winding transformed in accordance with the transformation ratio. Hence, the rectifier diode 105 feeds the capacitor 104, which must be able to accept the high current.

What is aimed at in this connection is that the resultant secondary a.c. voltage is rectified by the rectifier diode 105 and smoothed by means of the capacitor 104 and that a supply voltage, which is as smooth and as stable as possible, is made available for various electronic units. The secondary-side arrangement of the rectifier diode 105 and of the smoothing capacitor 104 proves, however, insufficient in some cases, a readjustment of the residual ripple of the output voltage being then necessary.

From U.S. Pat. No. 6,330,169 B2 (Mullett et al.) an output regulation system is known which allows independent output regulation of multi-output dc-dc switched-mode power converters. The channel resistances of MOSFET synchronous output rectifiers are controlled to obtain the voltage drop required to keep the respective output between predetermined limits concurrent with wide excursions in output load. A typical circuit has a transformer with an input winding coupled to a dc source. A transformer has at least a first and second output winding. A switched-mode regulator means samples a portion of the first output voltage and provides at least a first pulse-width modulated drive voltage having a first state and a second state to a first input semiconductor switch control terminal. The drive voltage first state turns the input semiconductor switch on and the drive voltage second state turns the input semiconductor switch off. The switched-mode regulator means is further characterized to adjust the ratio of the switch's on time to the switch's off time to control the first output voltage to remain within a predetermined range that is proportional to a precision reference voltage. A gate drive means is responsive to at least the first pulse-width modulated drive voltage for providing a first gate drive signal having a peak voltage swing to the synchronous rectifier control terminal. A control means samples a portion of the second dc output voltage and controls the peak voltage swing of the first gate drive signal to control the second output voltage to remain within a predetermined range.

The regulation system according to U.S. Pat. No. 6,330,169 B2 (Mulleft et al.), however, has the problem that the necessary circuitry is rather complex and cost-intensive. Moreover, as a connection between the secondary and the primary side of the transformator via the gate drive circuit is needed, the requirements which have to be met with respect to safety standards are problematic.

Consequently, there exists a need for an improved control circuit for controlling the output voltage of a primary-controlled switched mode power supply as well as a corresponding method for controlling an output voltage of a primary-controlled switched mode power supply, which permit an increased control accuracy and, simultaneously, a reduction of the physical size.

### SUMMARY OF THE INVENTION

The present invention is based on the finding that, in the case of insufficient smoothing of the output voltage, an inadmissibly high residual ripple of the output voltage can be compensated by the use of a secondary-side control circuit. Such a control circuit for controlling an output voltage of a switched mode power supply is provided according to one embodiment of the present invention. The switched mode power supply comprises a primary-side switch and a transformer with a primary winding and a secondary winding. The output voltage is adapted to be tapped at a capacitor which is connected in parallel to the secondary winding. The control circuit is adapted to be connected to a connection of the capacitor and to a connection of the secondary winding, said control circuit being a controllable synchronous rectifier, wherein no feedback connection between the secondary side to the primary side is required. The advantage of said controllable synchronous rectifier is that it can be used both in primary-controlled as well as in secondary-controlled switched mode power supplies for an analogue readjustment of residual ripples of the output voltages.

According to a further embodiment, the control circuit comprises a secondary-side switch with a parallel diode which is connected thereto in parallel, said secondary-side switch with the parallel-connected parallel diode being adapted to be connected to the secondary winding. The control circuit additionally comprises a synchronous rectifier controller for controlling the secondary-side switch, and a voltage control unit for controlling a turn-on level of said synchronous rectifier controller in dependence upon the output voltage. This arrangement is advantageous insofar the secondary-side switch can be controlled without having to use auxiliary windings, e.g. for providing reference voltages or other auxiliary voltages.

According to another embodiment, the secondary-side switch is a field effect transistor, the parallel diode being defined by an integrated diode which is connected between a source terminal and a drain terminal of the field effect transistor. The use of a field effect transistor as a secondary-side switch is advantageous insofar as it allows to dispense with the diode as an additional component. Furthermore, the field effect transistor is a commercially available and inexpensive component, which permits the control circuit to be produced at a reasonable price. Auxiliary windings need not be used in this case either.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention is illustrated in the accompanying drawings, wherein:

FIG. 1 shows a circuit diagram of a simple realization of a primary-clocked conventional switched mode power supply;

FIG. 2 shows a circuit diagram of a primary-controlled switched mode power supply with a control circuit according to the present invention; and

FIG. 3 shows a circuit diagram of a primary-controlled switched mode power supply with a control circuit according to a further embodiment.

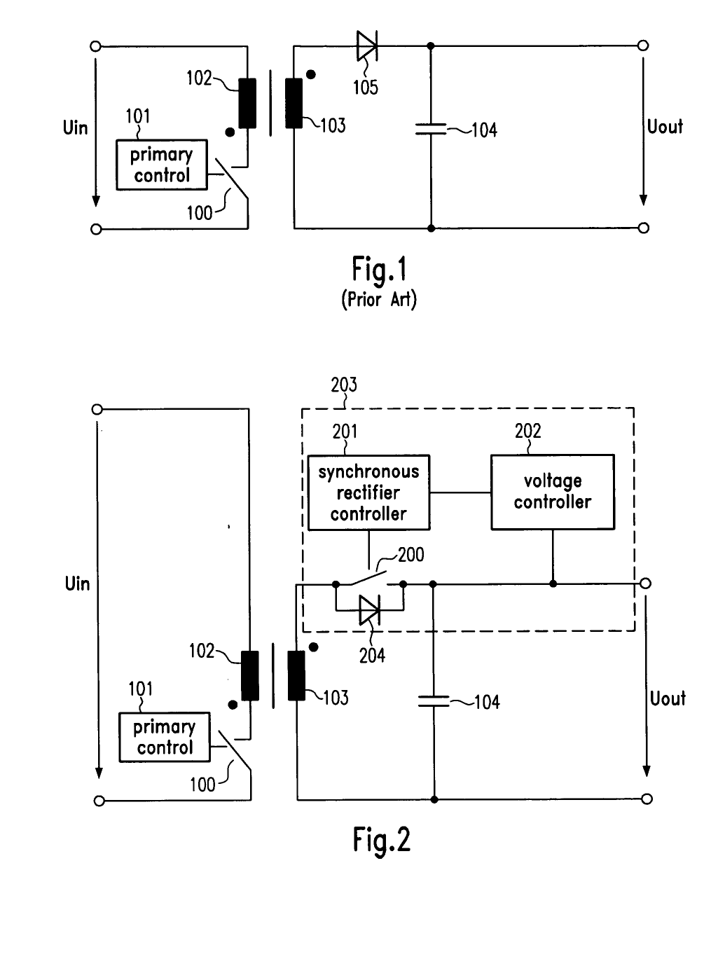

### DETAILED DESCRIPTION OF THE INVENTION

The illustrated embodiments of the present invention will be described with reference to the figure drawings wherein like elements and structures are indicated by like reference numbers.

Referring now to the drawings and in particular to FIG. 2 which is a circuit diagram of a simple realization of a primary-clocked conventional switched mode power supply, a control circuit 203 for controlling the output voltage of a primary-controlled switched mode power supply is shown in its application environment. The control circuit 203 comprises a secondary-side switch 200 and a parallel-connected parallel diode 204, said switch 200 being adapted to be connected to the secondary winding 103, a synchronous rectifier controller 201 for controlling the secondary-side switch and a voltage control unit 202 for controlling a turn-on level of the synchronous rectifier controller in dependence upon the output voltage Uout. The secondary-side switch 200 and the parallel-connected parallel diode 204 are arranged in series with the secondary winding 103. A capacitor 104 is connected to the series connection comprising the secondary winding and the switch with the parallel diode, the output voltage of the switched mode power supply being adapted to be tapped at the capacitor 104.

Starting from the secondary-side switch 200 and the parallel-connected parallel diode 204, the output voltage of the switched mode power supply is conducted outwards through a line. This line has also connected thereto the capacitor 104 and the voltage controller 202. This guarantees that the potential level of the output voltage will be fed back for controlling the switch 200 in dependence upon the output voltage.

The voltage controller 202 may be a simple conventional linear controller. The linear controller is adapted to control a turn-on level of the synchronous rectifier controller in dependence upon the output voltage Uout. The synchronous rectifier controller 201 can be an arbitrary conventional synchronous rectifier controller. The voltage controller 202 and the synchronous rectifier controller 201 define together with the electronic switch a control circuit, which is adapted to execute fine-tuning control of the output voltage Uout on the secondary side.

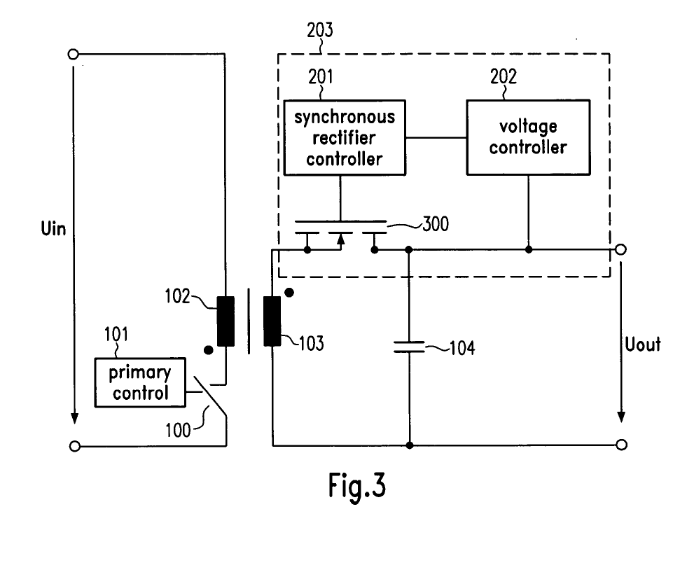

FIG. 3 shows an advantageous further development of the present invention in the case of which a field effect transistor 300 is used instead of the switch 200 and the parallel diode 204. According to this embodiment, the parallel diode 204 is defined by an integrated diode which is connected between the source terminal and the drain terminal of the field effect transistor 300. The integrated diode is often referred to as substrate diode.

The secondary-side field effect transistor 300 is controlled by the voltage controller 202 and the synchronous rectifier controller 201 in an analog manner in such a way that a residual ripple of the output voltage will be compensated. If the output voltage is, for example, too high by ΔU at a specific moment, the internal resistance between the source terminal and the drain terminal of the field effect transistor will automatically be adjusted such that precisely this ΔU will be compensated by a higher voltage drop across the internal resistance of the field effect transistor 300.

The control is effective in the voltage drop range of the diode path; in extreme cases, only the parallel diode in the field effect transistor will be effective, whereby a voltage drop of approx. 0.5 to 0.7 V will occur. A control deviation of the primary controller 101 of up to 0.5 V can be compensated in this way. Under full load, the voltage drop across the synchronous rectifier will be low because the field effect transistor will then be fully switched on. In this case, a maximum efficiency will be achieved, as if no control circuit with a controlled synchronous rectifier were provided.

Under low load, however, the output voltage of the device will increase due to the control deviation of the primary controller. The field effect transistor in the synchronous rectifier will then be blocked to such an extent that the increase in the output voltage will be compensated by the voltage drop across the internal resistor of the field effect transistor 300.

In the case of no-load operation, the synchronous rectifier no longer has a power-optimizing effect, but, since only a small current flows, this is scarcely noticeable as far as the power is concerned.

The present invention has the advantage that the residual ripple of the power pack voltage can be compensated by simple measures. In addition, when the controller according to the present invention is used, it will not be necessary to use auxiliary windings for generating auxiliary voltages which serve to execute control on the secondary side.

The above-described embodiments of the present invention allow to provide an improved switched mode power supply for generating an output voltage Uout. By means of the primary-side controller 101 a pre-control of the level of a primary-side voltage Uin is executed in dependence upon the output voltage Uout. By generating a secondary-side control signal in dependence upon the output voltage Uout, it is possible to execute, without the aid of an additional auxiliary winding, a secondary-side fine control of the output voltage Uout by controlling a voltage that drops across the secondary-side switch.

By means of this and also by means of all the other embodiments of the present invention described hereinbefore, a high control accuracy can be achieved and, consequently, it can be guaranteed that an existing residual ripple of the output voltage of a switched mode power supply will be fully compensated.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

In addition, those areas in which it is believed that those ordinary skilled in the art are familiar have not been described herein in order to not unnecessarily obscure the invention described herein. Accordingly, it is to be understood that the invention is not to be limited by the specific illustrated embodiments, but only by the scope of the appended claims.

1. A control circuit for controlling an output voltage of a switched mode power supply, wherein said switched mode power supply comprises a primary-side switch and a transformer with a primary winding and a secondary winding,
wherein the output voltage is adapted to be tapped at a capacitor which is connected in parallel to said secondary winding,
wherein said control circuit is adapted to be connected to a connection of the capacitor and a connection of the secondary winding,
wherein said control circuit is a controllable synchronous rectifier, and
wherein said control circuit is not connected to said primary-side switch.

2. A control circuit according to claim 1, further comprising:
a secondary-side switch with a parallel diode which is connected thereto in parallel, said secondary-side switch being adapted to be connected to the secondary winding,
a synchronous rectifier controller for controlling the secondary-side switch, and
a voltage control unit for controlling a turn-on level of said synchronous rectifier controller in dependence upon the output voltage.

3. A control circuit according to claim 2, wherein the secondary-side switch is a field effect transistor.

4. A control circuit according to claim 3, wherein the parallel diode is defined by an integrated diode which is connected between a source terminal and a drain terminal of the field effect transistor.

5. A control circuit according to claim 3, wherein the field effect transistor is operated as a controllable resistor.

6. A control circuit according to claim 3, wherein the field effect transistor is an n-channel insulated gate field effect transistor.

7. A control circuit according to claim 2, wherein the voltage control unit is adapted to limit the gate voltage of the field effect transistor in dependence upon the output voltage.

8. A control circuit according to claim 1, wherein a voltage, which is pre-controlled on the primary side at least in dependence upon the output voltage, is transmitted from the primary winding to the secondary winding.

9. A control circuit according to claim 1, wherein the switched mode power supply is a primary-controlled switched mode power supply.

10. A control circuit according to claim 1, wherein the switched mode power supply is a secondary-controlled switched mode power supply.

11. A switched mode power supply for generating an output voltage, said switched mode power supply comprising:
a primary-side switch and a transformer comprising a primary winding and a secondary winding, said output voltage being adapted to be tapped at a capacitor which is connected in parallel to the secondary winding, and
a control circuit for controlling said output voltage, wherein said control circuit is adapted to be connected to a connection of the capacitor and a connection of the secondary winding,
wherein said control circuit is a controllable synchronous rectifier, and
wherein said control circuit is not connected to said primary-side switch.

12. A method of controlling an output voltage of a switched mode power supply comprising a primary-side switch, a transformer with a primary winding and a secondary winding, said output voltage being adapted to be tapped by means of a control circuit at a capacitor which is connected in parallel to the secondary winding, said method comprising the following steps:
pre-controlling a level of a primary-side voltage in dependence upon the output voltage by a primary-side controller,
generating a secondary-side control signal in dependence upon the output voltage and applying the control signal to a synchronous rectifier controller,
controlling a voltage, which drops across a secondary-side switch, so as to execute fine-control of the output voltage on the secondary side,
wherein said control signal is not fed back to the primary side.
